(19) United States
(12) Patent Application Publication
(10) Pub. No.: US 2001/0011281 A1
(43) Pub. Date: Aug. 2, 2001

(54) Instant random display of electronic file through machine-readable codes on printed documents

(76) Inventor: Randolph A. Fry, Danville, CA (US)

Correspondence Address: RANDOLPH FRY, 967 RICHARD LANE, DANVILLE, CA, 94526, US

(21) Appl. No.: 09/681,272

(22) Filed: Mar. 12, 2001

(51) Int. Cl. G06F 15/00

(52) U.S. Cl. 707/500

(57) ABSTRACT

The present invention is a system and method for providing automated access to and display of electronic images stored in a database or in a local file/folder system. The system utilizes a machine-readable code on a document, referred to herein as an auto-identified document or one with an “autogram” since it stores its own file name in a symbol on the document*. The machine-readable symbol comprises encoded source data, wherein the source data comprises the file name. The machine-readable symbol is printed on the image as the image is printed. The presenter then scans the code via appropriate code scanning (e.g. bar code scanning) equipment, decodes the file name used to access the electronic image and display the image. In a preferred embodiment, a web browser program is launched on a local server on the client computer which has permission to access image files on any of the installed storage devices including magnetic and optical storage devices. A presenter, with thousands of hard copy documents, leafs to a single document, scans the bar code and the image is projected onto a wall or screen for an audience to view.* Emerging technologies allow the document to be identified through a characteristic image “signature” where the document is sampled by scanning a portion of it, converting the sample to a format common to the stored images (i.e. bmp) and matching the sample with a stored image in much the same way fingerprints are matched. Another emerging technology uses conductive ink to store the digital data directly on the document with no requirement to read data from another source to display an image of the document.

### CROSS REFERENCE TO RELATED APPLICATIONS

U.S. Pat. No. 6,108,656 Aug., 2000 Durst et al. 707/105,304,786 Apr., 1994 Pavlidis et al. 235/462. U.S. Pat. No. 5,649,186 Jul., 1997 Ferguson 707/10. U.S. Pat. No. 5,671,282 Sep., 1997 Wolffet al. 380/25. U.S. Pat. No. 5,682,540 Oct., 1997 Klotz, Jr. et al. 395/766. U.S. Pat. No. 5,710,887 Jan., 1998 Chelliah et al. 705/26. U.S. Pat. No. 5,745,681 Apr., 1998 Levine et al. 395/200. U.S. Pat. No. 5,757,917 May, 1998 Rose et al. 380/25. U.S. Pat. No. 5,765,176 Jun., 1998 Bloomberg 707/514. U.S. Pat. No. 5,778,367 Jul., 1998 Wesinger, Jr. et al. 707/10. U.S. Pat. No. 5,791,991 Aug., 1998 Small 463/41. U.S. Pat. No. 5,848,413 Dec., 1998 Wolff 707/10. U.S. Pat. No. 5,933,829 Aug., 1999 Durst et al. 707/10. Foreign Patent Documents WO 98/24036 Jun., 1998 WO. WO 98/24050 Jun., 1998 WO. WO 98/40823 Sep., 1998 WO. WO 98/49813 Nov., 1998 WO.

### BACKGROUND OF INVENTION

In recent years enormous efforts have gone into connecting various computer resources through the distributed world wide web. Internet scripting languages for client and server computers, combined with style and XML capability have made internet browsers very powerful, leading to web applications that can rival traditional computer software applications. With these increased web browser capabilities, the inclusion of web servers in the personal computer operating system, and the addition of a low cost database it is possible to run a complete internet application on a local computer, without ever connecting to a network. This means that the internet application can come full circle back to the users computer while taking advantage of the web software tools available for rapid development of internet applications.

The subject invention is intended for the presentation of documents and images (later referred to as “document” or “image”). For instance, teachers use chalk/white boards, overhead projectors or books for graphic presentations to involve students in the learning process. Logistical and cost considerations have placed practical limits on the use of these materials. We have seen on TV presentations using laptop computers and digital image projection equipment. The potential of presenting prepared material through this medium is only limited by digital storage devices. It has the advantage of being dynamic in presentation in that the presenter can zoom in on or select and display over the base document sections of the document to add emphasis and draw attention to details which might otherwise be overlooked. Additionally, audiences are more effectively engaged in the these details which could otherwise become boring and loose impact.

Adobe's Acrobat Reader or a similar software application has the capability to present documents by placing the scanned images in a wrapper “*.pdf” file that contains all the presentation materials. Images are easily accessed and projected using a laptop connected to a digital projector. The zoom and select functions provide effective tools for presenter to focus attention on pertinent details. An included file system allows easy access to the next document or random access to any image in the file.

One problem is keeping the displayed documents in sync with the presenters instruction materials. Another problem is that attention is focused on the computer operating system thus reducing the effectiveness of the presenter. If the presenter is not intimately familiar with their documents and how to locate them in their chosen presentation software application or they are not very skilled in the use of a personal computer he/she may even deny themselves this powerful tool because of the uncertainty of its functionality and reliability. The subject invention allows the presenter to go back to the materials he/she is most comfortable which are the hard copies of the documents by including an “autogram” in the field of the document.

With the inclusion of this coded symbol of the document's scanned file name, the presenter has only to scan the symbol with a bar code reader and the image is instantly (no networking or internet involved) displayed. The focus of the presenter has not been diverted to operating a computer.

It is difficult to use a keyboard to designate the file to be display. It is less difficult to use a mouse to open a file management list and select the desired document for display. It is even easier to progress sequentially through images with “next” and “previous” buttons, but has the disadvantage of not being able to rapidly respond to changing display requirements. It would be quite advantageous to use the presenters hard copies to automatically display the document.

### SUMMARY OF THE INVENTION

The present invention is a system and method for providing automated access to and display of electronic images stored in a database or file/folder system. The system utilizes a machine-readable code on a document, referred to herein as a self-identifying document or one with an “autogram” since it stores its own file name in a symbol on the document. The machine-readable symbol comprises encoded source data, where the source data is the file name. The machine-readable symbol is printed on the image as the image is printed. The presenter then scans the code via appropriate code scanning (e.g. bar code scanning) equipment, decodes the file name used to access the electronic image and display the image. In a preferred embodiment, a web browser program is launched on a local server on a computer which has permission to access image files on any of the installed storage devices including magnetic and optical storage devices. A presenter, with thousands of hard copy documents, leafs to a single document, scans the bar code and the image is retrieved and projected onto a wall or screen for an audience to view.

Emerging technologies allow the document to be identified through a characteristic image “signature” where the document is sampled by scanning a portion of it, converting the sample to a compatible digital format and matching the sample with a stored image in much the same way fingerprints are matched. Another emerging technology uses conductive ink to store the digital image data directly on the document with no requirement to read data from another source to display an image of the document.

### BRIEF DESCRIPTION OF DRAWINGS

FIG. 1 is a diagram of the system of the present invention including an isolated computer 40, a document scanner 22, printer 23, bar code scanner 26 and digital projector 71.

FIG. 2 is a detail diagram of the document generator process 50.

FIG. 3 is a detail diagram of the browser web pages 60.

### DETAILED DESCRIPTION

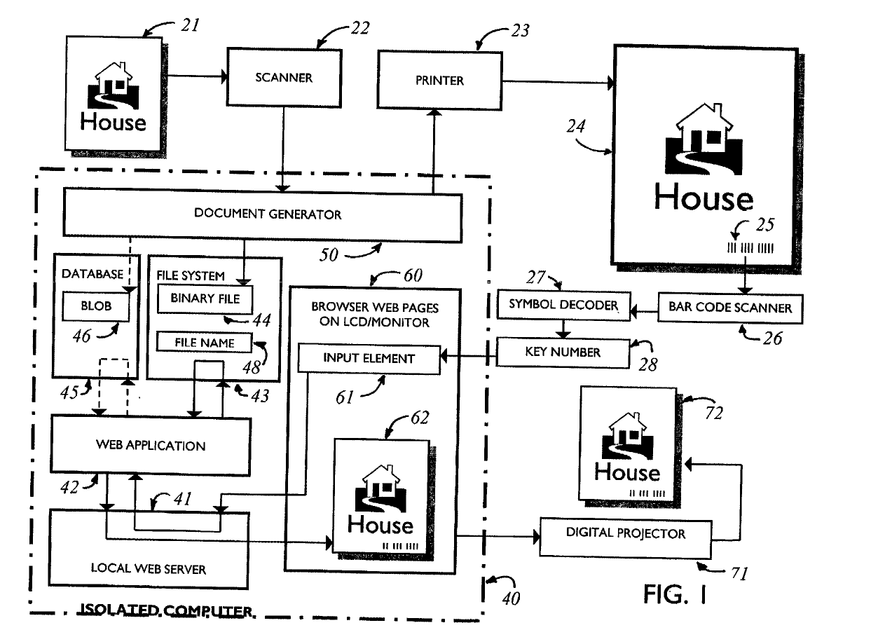

The system of the present invention for generating, reading and displaying an “autogrammed” document is illustrated in block diagram form in FIG. 1. The document generation process is comprised of an “autogrammed” document generator 50 which acquires an image 21 using a scanner 22, generates an image file name and stores the image in a file system 43 as a binary file 44 with a file name 48. The document generator 50 sends the image and encoded file name to the printer 23 generating the hard copy document 24 with an “autogram” 25. The document display process is started when a bar code scanner 26 is moved over an “autogram” 25 on a randomly selected document 24. A symbol decoder 27 in the bar code scanner 26 sends key numbers 28 to an input element 61 in a browser web page 60 on an isolated computer 40. The local web server 41 runs the requested web application 42 retrieving the previously stored binary file 44 from the file system 43 using the file name 48. The local web server 41 then send the requested document to the browser 60 resulting in the displayed document 62 on the monitor and the projected document 72 using the digital projector 71.

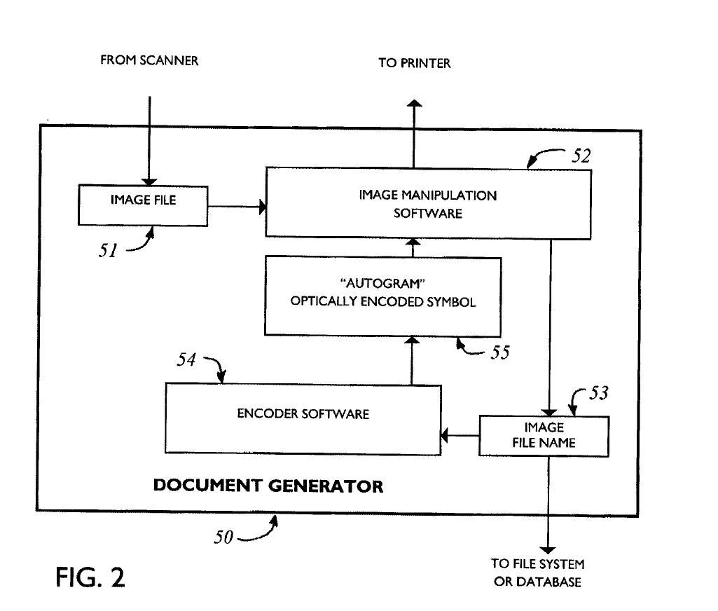

The document generator 50 is detailed in FIG. 2. A digital image file 51 is processed in the image manipulation software 52 and given an image file name 53 which is stored in the file system 43 (FIG. 1) or database 45 (FIG. 1). The file name 53 is encoded by the encoder software 54 producing an “autogram”—optically encoded symbol 55. The “autogram” 55 is sent to the image manipulation software 52, combined with the image file 51 and sent to the printer 23 (FIG. 1).

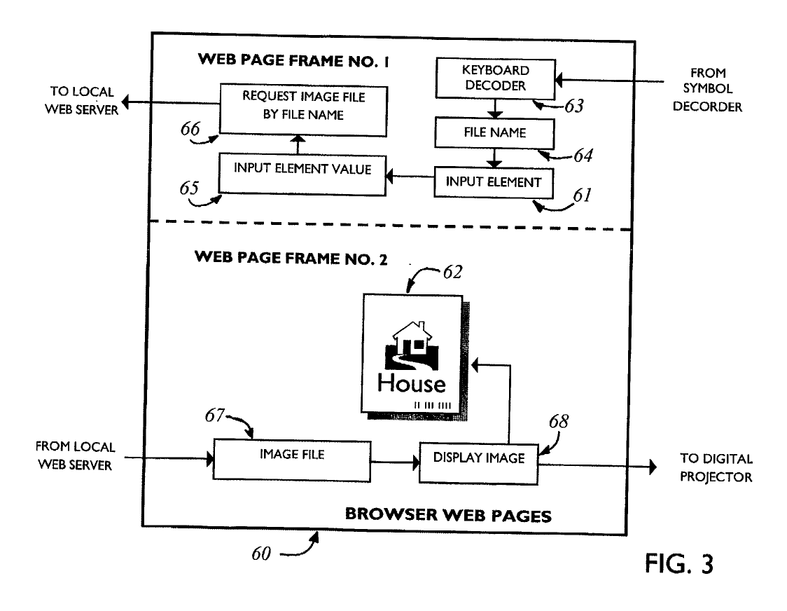

The browser web pages 60 are detailed in FIG. 3. A browser web page 60 receives key numbers 28 (FIG. 1) from the symbol decoder 27 (FIG. 1) as input to the keyboard decoder 63 generating a file name 64 which is placed in the input element 61. The input element value 65 is included in a request for image file by file name 66 and sent to the local web server 41 (FIG. 1). The local web server 41 (FIG. 1) returns the request image file 67 and displays the image 68 and 62 in a browser web page 60. The display image 68 signal is also sent to the digital projector 71 (FIG. 1) for projection 72 (FIG. 1).

1. A method for an isolated computer to retrieve and display a computer file comprising the steps of: a) encoding a human readable data string comprising a file name into a machine readable symbol; b) rendering said machine readable symbol within a data carrier; c) transferring an input data string from said machine readable symbol with a computer input device coupled to said computer; d) parsing said input data string to determine said file name; and e) utilizing said file name to request the named computer file, by assembling a computer file transfer request expression (string) comprising said file name, and transmitting said computer file transfer request expression to a local server on the computer; f) said local server receiving said computer file transfer request expression and g) said local server transmitting a computer file to said computer in response thereto; and h) said computer displaying said computer file.

2. The method of claim 1 wherein said computer is connected to the Internet, and wherein said request expression is directed towards a target server computer in communication with the Internet.

3. The method of claim 1 wherein said computer is connected to an intranet, and wherein said request expression is directed towards a target server computer on the afore-montioned intranet.

4. The method of claim 2 wherein said request expression includes a uniform resource locator (URL) for specifying a target server in communication with the Internet.

5. The method of claim 3 wherein said request expression includes a network address for specifying a target server on the intranet.

6. A method for an isolated computer to retrieve and display a computer file comprising the steps of: a) encoding a representation of a characteristic digital sample of a file into a machine readable symbol; b) rendering said machine readable symbol within a data carrier; c) transferring an input data string from said machine readable symbol with a computer input device coupled to said computer; d) parsing said input data string to determine said characteristic digital sample; and e) utilizing said characteristic digital sample to request the represented computer file, by assembling a computer file transfer request expression (string) comprising said characteristic digital sample, and transmitting said computer file transfer request expression to a local server on the computer; f) said local server receiving said computer file transfer request expression and g) said local server transmitting a computer file to said computer in response thereto; and h) said computer displaying said computer file.

7. The method of claim 6 wherein said computer is connected to the Internet, and wherein said request expression is directed towards a target server computer in communication with the Internet.

8. The method of claim 6 wherein said computer is connected to an intranet, and wherein said request expression is directed towards a target server computer on the afore-montioned intranet.

9. The method of claim 7 wherein said request expression includes a uniform resource locator (URL) for specifying a target server in communication with the Internet.

10. The method of claim 8 wherein said request expression includes a network address for specifying a target server on the intranet.
